(19) United States
(12) Patent Application Publication
(10) Pub. No.: US 2025/0143419 A1
(43) Pub. Date: May 8, 2025

(54) A COVER FOR A RING

(71) Applicant: TAYLORED TECHNOLOGIES LIMITED, HAMILTON (NZ)

(72) Inventors: Luke TAYLOR, HAMILTON (NZ); Rachel KELLY, HAMILTON (NZ); Steve CORMACK, HAMILTON (NZ)

(21) Appl. No.: 18/691,011

(22) PCT Filed: Nov. 2, 2022
(86) PCT No.: PCT/IB2022/060537

§ 371 Date: Mar. 11, 2024

(30) Foreign Application Priority Data
Nov. 2, 2021 (NZ) 781941

(51) Int. Cl. A44C 9/00

(52) U.S. Cl. CPC A44C 9/0092

(57) ABSTRACT

A protective cover for a smart ring comprising an annular member formed from flexible material adapted to stretch over a ring and wherein in use and when fitted to a ring it covers the exterior surfaces of the ring and also being configured such that it does not affect the contact between internal sensors of the smart ring and the skin of the ring wearer's finger.

### FIELD OF INVENTION

The invention generally relates to a cover for a ring. A preferred form of the invention relates to a protective cover for a smart ring, although it should be understood that the invention is not limited to this. This application claims priority to NZ 784941 filed 2 Nov. 2021 incorporated herein in its entirety.

### BACKGROUND

Wearable devices such as smart rings are prone to damage from day to day use. As these devices are typically expensive replacing them is undesirable. There are known protective covers for smart rings however they are not customized to the ring which causes discomfort to the user and can result in the cover being displaced and the ring damaged. These known covers can also affect the contact between the ring's internal sensors and the wearer's fingers which impacts the function of the smart ring.

It is an object of a preferred form of the present invention to go at least some way towards addressing one or some of the above problems. While this is an object of a preferred embodiment, it should not be seen as a limitation on the scope of the invention as claimed. The object of the invention per se is simply to provide the public with a useful choice.

The term “comprising” and derivatives thereof, e.g. “comprises”, if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there is provided a protective cover for a smart ring comprising an annular member formed from flexible material adapted to stretch over a ring and wherein in use and when fitted to a ring it covers the exterior surfaces of the ring and also being configured such that it does not affect the contact between the internal sensors of the ring and the skin of the ring wearer's finger.

In some forms the cover is adapted to stretch to cover a plurality of standard ring sizes.

In some forms the cover has been adapted such that it fits ring sizes 3-5

In some forms the cover has been adapted such that it fits ring sizes 6-9.

In some forms the cover has been adapted such that it fits ring sizes 10-13 or above.

In some forms the cover has a thickness of about 0.6 mm-1.5 mm.

In some forms the cover has a thickness of about 0.8 mm-1.2 mm.

In some forms the cover is adapted such that it stretches over any features on the outer surface of a smart ring.

In some forms the cover has an inner surface, an outer surface and curved side walls joining adjacent ends of the inner and outer surfaces.

In some forms when in use the side walls extend radially inwards towards covering the annular surfaces of the ring in the distal and proximal directions.

In some forms the side walls are the same size or slightly smaller than the annular surfaces of the ring.

In some forms the side walls are between about 0.6 mm and 1.5 mm thick.

In some forms the side walls are between about 0.6 mm and 1.2 mm thick.

In some forms the side walls are between about 0.8 mm and 1.0 mm thick.

In some forms the cover does not engage the bottom surface of the ring.

In some forms when in use with a ring the cover and attached ring can be removed at the same time from a wearer's finger.

In some forms when in use with a ring the cover can be removed from an attached ring from a wearer's finger.

In some forms when in use the cover can be attached to a ring when the ring is being worn on a wearer's finger.

In some forms when in use and fitted to a ring the cover is adapted such that it limits movement between the ring and the cover so that twisting motions or friction between the covered ring and another hard object does not alter the placement of the cover.

In some forms the cover is adapted to protect the ring from damage, impact or shock.

In some forms the cover is made from a resilient plastic material.

In some forms the cover is made from a thermoplastic including a combination of plastics polymers such as polyurethane and polyethylene.

In some forms the cover is made from thermoplastic polyurethane.

In some forms the cover is translucent or transparent.

In some forms the cover is opaque.

In some forms the cover is anti-microbial.

In some forms the cover is waterproof or water resistant.

In some forms the cover is dust proof.

In some forms the cover has a logo on it.

In some forms the cover is made from injection moulding.

According to a further aspect of the invention there is provided a protective cover for a ring comprising an annular member formed from thermoplastic polyurethane and being adapted to stretch over three different ring sizes and wherein in use and when fitted to a ring it covers the exterior surfaces of the ring.

According to a further aspect of the invention there is provided a protective cover for a smart ring, the protective cover comprising an annular member formed from flexible material adapted to stretch over the outer face of the ring, the annular member including two annular edges, each edge including an annular side wall extending radially inwards around the perimeter of the edges of the annular member.

These and other features, objects and advantages of the present invention will be readily apparent to persons of ordinary skill in the art upon reading the entirety of this disclosure, which includes the accompanying drawings.

### BRIEF DESCRIPTION OF THE DRAWINGS

Some preferred embodiments of the invention will now be described by way of example and with reference to the accompanying drawings, of which:

FIG. 1 is a front view of a cover for a ring;

FIG. 2 is a cross-sectional view of the cover for a ring shown in FIG. 1 through the line A-A.

FIG. 3 is a front view of an alternative embodiment for a ring;

FIG. 4 is a cross-sectional view of the cover for a ring shown in FIG. 3 through the line A-A; and

FIG. 5 is a perspective exploded view of a cover for a ring and the ring to be covered.

FIG. 6a is an isometric view of a cover for a ring;

FIG. 6b is top view of a cover for a ring;

FIG. 6c is side view of a cover for a ring;

FIG. 6d is bottom view of a cover for a ring;

FIG. 7 is a perspective view of a ring cover.

### DETAILED DESCRIPTION

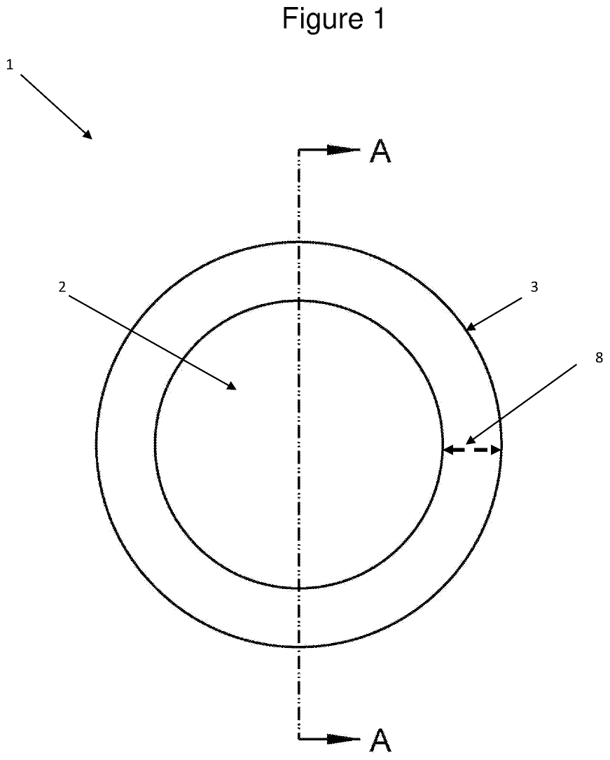

FIG. 1 shows a protective cover 1 for a ring. The cover 1 is most preferably used with a smart ring however it will be appreciated that the cover 1 may be used with other types of rings e.g. wedding and engagement rings etc and of rings of any size.

Reference to smart rings throughout the specification relates to any type of ring containing mobile components such as sensors and NFC chips.

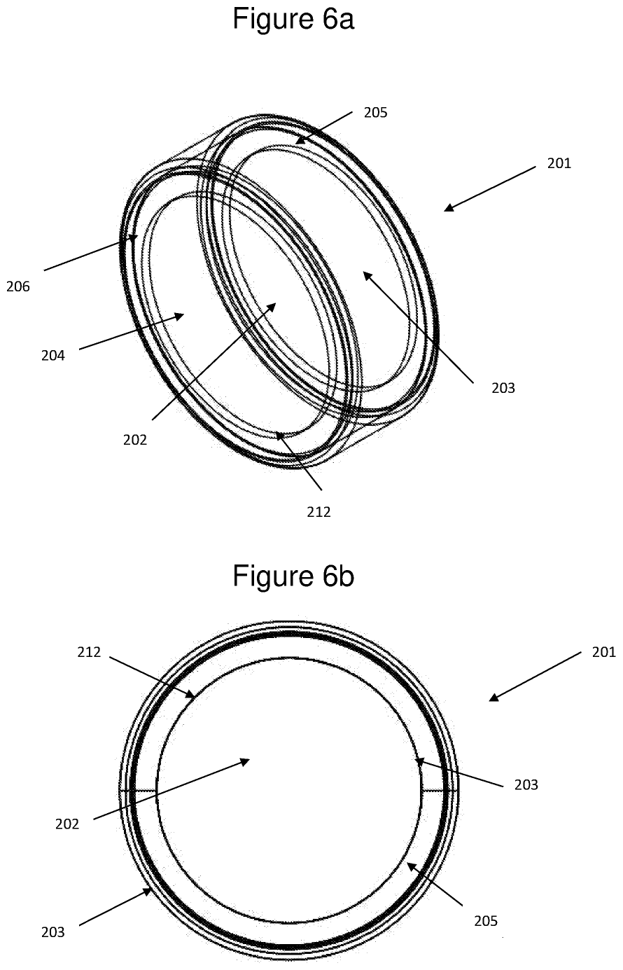

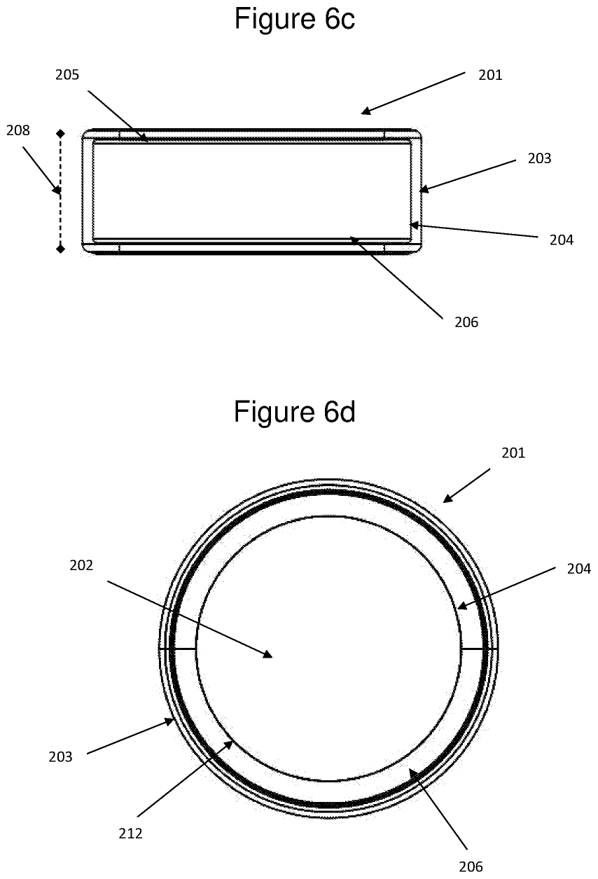

As can be seen from FIGS. 1 and 6a to 6d the cover 1, 201 is circular in shape and has an opening 2 to receive a ring or a finger which is wearing a ring. The cover 1 is composed of one solid piece of material and is preferably made from thermoplastic material including polyurethane, polypropylene or polyethylene or combinations thereof, however those skilled in the art will appreciate that other types of materials with similar properties may be used such as rubber, silicone, other polymers or mixtures thereof. The cover 1 is adapted to cover/encircle the exterior surfaces of a ring when in use such that it protects the outer surfaces of the ring. The cover 1, has an inner surface (not visible in this figure) which receives a ring when in use and also has an outer surface 3.

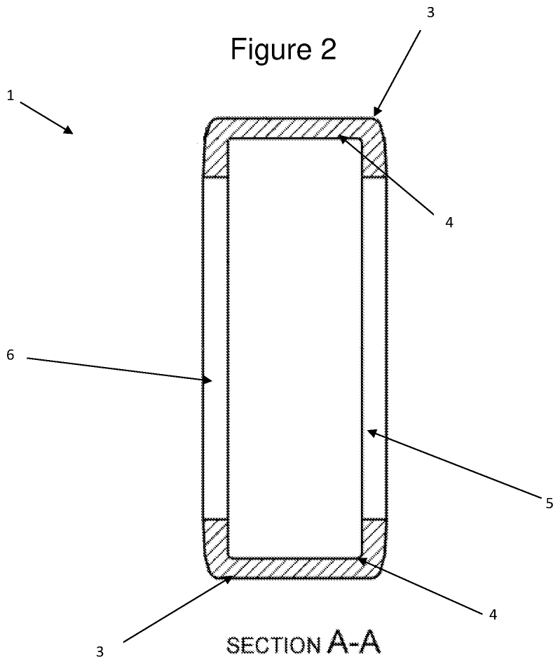

FIG. 2 shows a cross sectional view of the cover 1 which has been adapted for standard ring sizes 6, 7, 8 or 9.

The inner surface 4 of the ring cover 1 can be seen in this figure and the inner surface 4 and the outer surface 3 are joined on opposed ends by two curved side walls 5, 6Attachment to a ring is assisted by the side walls 5, 6 of the cover 1. When in use the sides walls 5, 6 extend radially inwards towards covering the annular surfaces of the ring in the distal and proximal directions. The sidewalls 5, 6 of the ring cover 1 are the same size or slightly smaller than the annular surfaces of the ring and the sidewalls 5, 6 do not extend radially inwards beyond the extent of the ring itself, for size 6-9 rings, this is on average about between 2 mm-3 mm, although the size may fall outside this range if the ring is particularly thick or thin. This is so that the ring cover 1 sidewalls 5, 6 do not prevent or adversely affect the ring making reliable contact with the sensors of the ring and the skin of the wearer's finger as this contact is required for smart rings in order for its sensors to function. For example, when designed for use with a size 6 ring, cover 1 may have an internal diameter of between 21 mm and 23 mm, preferably 21.0 mm to 22.10 mm such as 21.70 mm. The cover 1 is equal to or less than almost an exact size-for-size fit around a size 6 ring outer diameter. There a slight stretch fit for the cover 1 as smart rings often have some cosmetic feature(s) on their outer surface (e.g. a small raised flat region, or a small raised peak/edge) which effectively adds to their nominal diameter.

In some forms the cover 1 has an internal diameter smaller than the outer diameter of the ring, such as about a ring size smaller, such that a cover for size 6 ring would be about the size of a size 5 ring. This is to allow for stretch of the material and ensure a tight fit. A tight fit supports the cover being retained on the ring and also reduces water ingress between the ring and cover.

The cover width 8, 208 (see dashed arrows in FIG. 1 and FIG. 6c) that fits over the outer surface of the ring is less than the width of the ring to support a snug or tight fit around the ring. The width of the cover 1, 101, 201 will vary depending on the size of the ring. For example, the cover width 8, 208 may be in the range of 10 mm to 6 mm, preferably between 9 mm and 7.5 mm, more preferably less than 8 mm, such as 7.85 mm or less to ensure there was adequate ‘snugness’ and reduce water entry

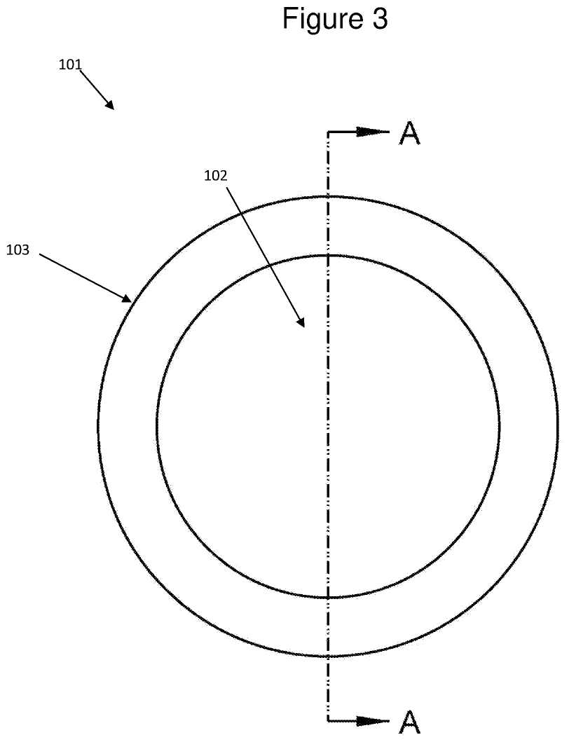

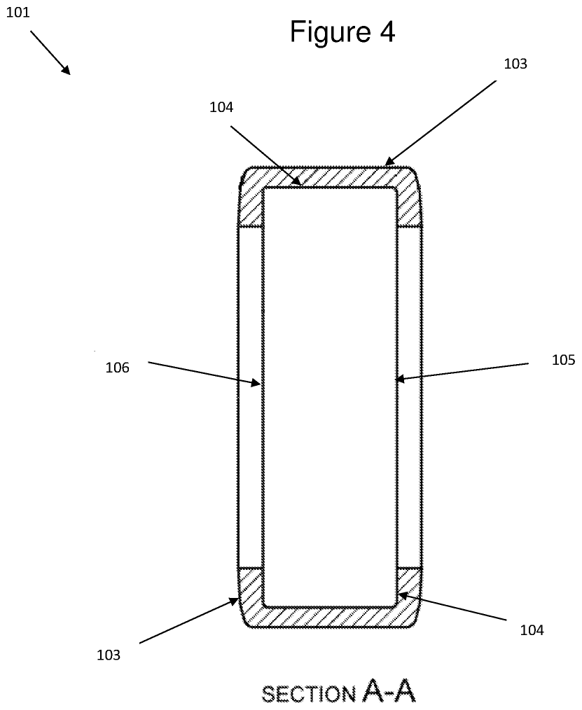

FIGS. 3 and 4 show an alternative embodiment of a cover 101 for a ring. This cover 101 is also circular in shape and has an opening 102, an outer surface 103, an inner surface 104 and two side walls 105, 106. The cover 101 is adapted for ring sizes 10-13 and is designed with larger dimensions than the example shown in FIG. 2. In this example, ring cover 101 has an internal diameter of 25.40 mm, which is a near size-for-size fit on a size 10 outer diameter with aesthetic features of the ring adding to this. Each subsequent increment (in this 10-13 range it is around 3.0% as the sizes are bigger but the step size is the same in absolute terms, meaning the relative change is less) again stretches the cover 1 by a relatively small amount, well within the elastic capabilities of the cover 1.

FIGS. 6a to 6d show an alternative embodiment of a cover 201 for a ring. This cover 201 is also circular in shape and has an opening 202, an outer surface 203, an inner surface 204 and two side walls 205, 206. The side walls 205 and 206 may act as side skirts around the side edge of the ring in use. The edges of the cover 201 are curves surfaces to provide a smooth edge.

The cover 1, 101, 201 may be formed in a number of different sizes to accommodate different size rings, for example a small, medium and large size cover. Each cover size adapted to fit a range of ring sizes such as two, three or more ring sizes. The internal diameter of the cover may be less than 27 mm, for example the internal diameters for small, medium and large covers 1, 101, 201 may be about 26.5 mm, 24.15 mm or 21.70 mm, however a skilled addressee would understand that other internal diameters may be used provided the cover 1, 101, 201 securely covers and is retained on and over the outer surface of the ring.

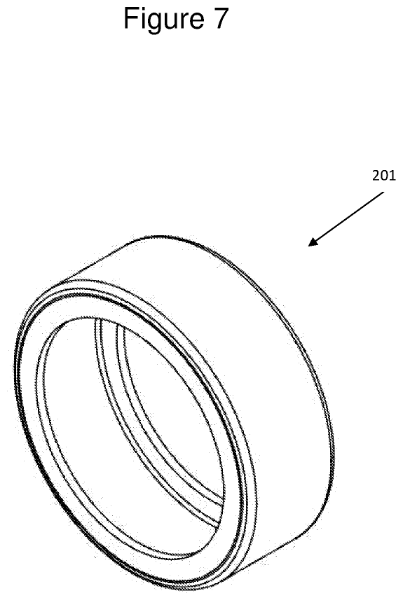

FIG. 7 shows a perspective view of a cover 201 similar to that shown in FIGS. 6a to 6d.

The covers 1, 101, 201 have a degree of stretch of approximately 3.0% as this allows for the ring covers 1, 101, 201 to be stretched over a ring and to retain itself firmly on the ring. It will be appreciated in alternative embodiments the cover can stretch more or less than this. The stretch of the material, and the geometric design of the ring cover 1, 101, enables a single ring cover 1, 101, 201 to accommodate a range of ring sizes. The ring cover 1, 101, 201 is designed for a nominal minimum ring size, and then in addition to that particular ring size, the ring cover 1, 101, 201 can also be used for multiple larger ring sizes.

The material thickness of the sidewalls 5, 6, 105, 106 is at its maximum at the inner extent of the sidewalls (see 212 shown on FIG. 6a). These thickened sections help to retain the cover 1, 101, 201 on the ring by providing a relatively stiff section that snaps over the ring when in use. In some forms the thickened edge of the sidewall 212 may act as a bead to help retain the cover 1, 101, 201 on the ring by providing a relatively stiff section that may snap over the ring. Elsewhere on the ring cover 1, 101 the material thickness is kept to a relative minimum, preferably less than 1.5 mm such as 1.2 mm, 1.0 mm or 0.8 mm. This is so that it is not excessively bulky and obtrusive on the wearer's finger. For example, the sidewall thickness may be 1.5 mm thick at the inner extent of the side wall, tapering to a 1.2 mm width closer to outer surface 103. In other embodiments the sidewall thickness may be any size within the range 0.5 mm-3 mm, such as 0.8 mm to 2 mm depending on the size of the ring to be covered. In one form the maximum at the inner extent of the sidewalls 5, 6, 105, 106 is 1.0 mm and the other side wall thickness is about 0.8 mm.

In one form the thickness of the cover 1, 101, 201 around the main outer surface 3, 103, 203 of the cover and/or the side walls 205, 206 of the cover are about 0.8 mm. This thickness provides a smaller profile while still provide sufficient cushioning effect to the wearer of the ring.

Although only two examples of ring covers 1, 101, 201 have been described above it will be appreciated that the covers 1, 101, 201 can come in different sizes/dimensions.

The design of the cover 1, 101, 201 which when in use securely fits around the ring without interfering with the ring's fit on the finger and enables the ring and cover 1, 101, 201 to be taken off together. The ring cover 1, 101, 201 may be placed over a ring while the ring is on a ring-wearer's finger and removed while the ring is still on the ring wearer's finger. The ring cover 1, 101, 201 has been designed to be form-fitting which limits movement between the ring and the cover 1, 101, 201 so twisting motions or friction between the covered ring and another hard object does not alter the placement of the cover 1, 101, 201 doesn't impede sensor contact, nor negatively impact the wearers comfort.

As previously mentioned the protective cover 1, 101, 201 may be made from thermoplastic polyurethane, polypropylene, polyethylene or combination thereof which are durable, have a high resistance to tearing and are biologically inert. Thermoplastic polyurethane has a relatively high co-efficient of friction against ring surfaces such that the cover 1, 101, 201 grips the ring and this helps to prevent accidental dislodgement of the cover 1, 101, 201 or other movement relative to the ring.

In a first specific example of the manufacture of a translucent or opaque cover, a black thermoplastic polyurethane with 55 Shore Hardness (Shore Hardness scale 00) is combined with a 2-10% polypropylene additive.

In a second example of the manufacture of a transparent cover a high clarity, medical-grade thermoplastic polyethylene with 55 Shore Hardness was used.

These compositions were found to provide the required balance of tensile strength, tear resistance, stretch and memory capability, durability and aesthetics. The use of the high clarity, medical-grade thermoplastic polyurethane provided optimum optical clarity to allow the ring's colour to show through the cover.

Materials within a range of 40-70 on the Shore Hardness 00 scale may be used to prepare the ring covers, with the preferred level being 55-60.

In some instances the material of the ring cover 1, 101, 201 can be anti-microbial, water proof or water resistant and/or dust proof. In alternative embodiments the ring cover 1, 101, 201 can have a logo which could be moulded into the cover 1, 101, 201 or added by other suitable means such as printing, engraving, laser etching, decal or the like. In another embodiment the ring cover 1, 101, 201 may be transparent or translucent so that the ring is visible when the ring cover 1, 101, 201 is attached. The ring cover 1, 101, 201 can also come a number of different colours and patterns and may be opaque to hide the ring. In some embodiments the cover 1, 101, 201 may have an aperture or apertures to allow for stones or the like to pass through.

Different areas of the ring cover may be made from different materials and a combination of materials may be used in one ring cover to impart different structural characteristics on different regions of the ring cover. For example, the curved side walls may be made from a different material or combination of materials than the cover portion.

The cover 1, 101, 201 is preferably made from injection moulding using a tool mould however it will be appreciated that the cover 1, 101, 201 can be made in other suitable ways.

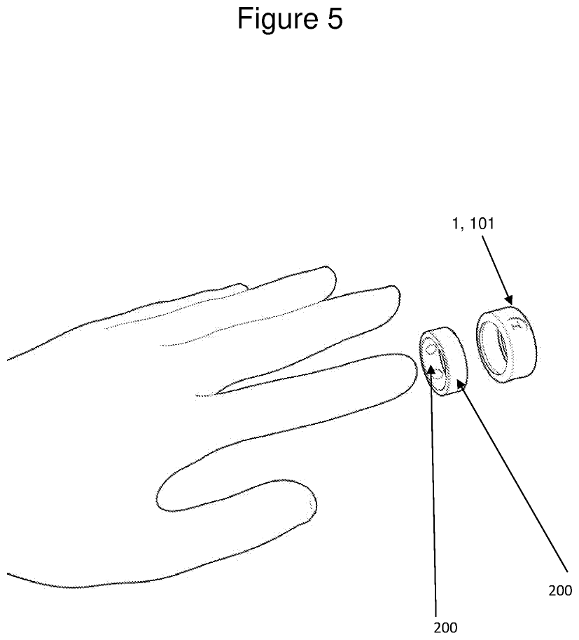

FIG. 5 shows cover 1, 101, 201 in an exploded perspective view demonstrating how the ring cover is to be used. Cover 1, 101, 201 is placed over a smart ring 200, which is fitted to a wearer's finger. Cover 1, 101, 201 surrounds and protects ring 200 on three sides, enabling unrestricted contact between the inside surface of the ring 201 and the wearer's finger.

The cover 1, 101, 201 has a number of advantages/benefits. Some known ring covers are made from silicone rubber which is comparatively weak and easy to tear as opposed to the cover 1, 101, 201 which is made from thermoplastic polyurethane. Known ring covers can also cover the internal sensors of smart rings which affects the function of the device and makes it unfit for purpose. As the cover 1 has been customised to ring sizes the cover 1, 101, 201 does not cause discomfort to the wearer like other ring covers and the cover 1, 101, 201 does not displace easily. Due to the design and moulding of the cover 1, 101, 201 there is no unnecessary bulk which makes the cover 1, 101, 201 much more aesthetically pleasing than known ring covers. The cover 1, 101, 201 can be used during exercise or day to day activities to protect the ring from damage, shock or impact. The cover 1, 101, 201 can also be used to protect items from being damaged from contact with the ring which is a known problem. Unlike some ring covers the cover 1, 101, 201 is capable of being placed over a ring whether such ring is on or off a ring-wearer's hand and is capable of remaining on a ring after the ring has been removed from a ring-wearer's hand for protection of the ring during storage or transport. The cover 1, 101, 201 is also capable of being placed on a ring after the ring has been removed from a ring-wearer's hand for protection of the ring during storage or transport.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the cover 1, 101, 201 may vary dependent on the particular application for which it is used without variation in the spirit and scope of the present invention.

1. A protective cover for a smart ring comprising an annular member formed from flexible material adapted to stretch over a ring, the protective cover having a circular shape comprising an inner surface, an outer surface and side walls joining adjacent ends of the inner and outer surfaces, and wherein in use and when fitted to a ring the side walls extend radially inwards along an annular surface of the ring and the inner surface receives the exterior surfaces of the ring, wherein the diameter of the inner surface is smaller than the outer diameter of the ring and the side walls are configured to ensure the contact between internal sensors of the smart ring and the skin of the ring wearer's finger is maintained.

2. The protective cover of claim 1, wherein the cover is adapted to stretch to cover at a plurality of standard ring sizes.

3. The protective ring cover of claim 1, wherein the cover has been adapted such that it fits ring sizes 3-5, 6-9 or 10-13 or above.

4. The protective ring cover of claim 1, wherein the cover has a thickness of about 0.6 mm-1.5 mm.

5. The protective ring cover of claim 1, wherein the cover is adapted such that it stretches over any features on the outer surface of a smart ring.

6. The protective ring cover of claim 1, wherein the side walls do not extend radially inwards beyond the annular surface of the ring.

7. The protective ring cover of claim 1, wherein the side walls extend radially inwards covering the annular surface of the ring in the distal and proximal directions.

8. The protective ring cover of claim 1, wherein the side walls are smaller than the annular surfaces of the ring.

9. The protective ring cover of claim 6, wherein the side walls are between about 0.6 mm to 1.2 mm thick.

10. The protective ring cover of claim 1, wherein when in use and fitted to a ring the protective cover is adapted such that it limits movement between the ring and the cover so that twisting motions or friction between the covered ring and another hard object does not alter the placement of the cover.

11. The protective ring cover of claim 1, wherein the protective ring cover is made from a resilient plastic material.

12. The protective ring cover of claim 11, wherein the cover is made from thermoplastic material or a silicone material.

13. The protective ring cover of claim 12 wherein the cover is made from a thermoplastic polyurethane, polypropylene or polyethylene or combinations thereof.

14. The protective ring cover of claim 13, wherein the thermoplastic polyurethane has a Shore Hardness 00 of 50-60.

15. The protective ring cover of claim 14, wherein the thermoplastic polyurethane has a Shore Hardness 00 of 55.

16. The protective ring cover of claim 12, wherein the cover is made from a thermoplastic polyurethane and a 2-10% polypropylene additive.

17. The protective ring cover of claim 12, wherein the thermoplastic polyurethane is a high-clarity, medical-grade thermoplastic polyurethane.

18. (canceled)

19. (canceled)

20. A protective cover for a smart ring according to claim 1 when fitted to a smart ring.

21. The protective cover according to claim 1 wherein when fitted to a ring, the flexible material is configured to have sufficient stretch to ensure a tight fit over the ring to support the cover being retained on the ring and reducing water ingress between the ring and cover in use.

22. The protective cover according to claim 1 wherein when fitted to a ring, movement between the ring and the cover is substantially prevented.

23. The protective ring cover of claim 1, wherein material has a Shore Hardness 00 in the range of 40 to 70.
